(19) United States
(12) Patent Application Publication
(10) Pub. No.: US 2026/0295696 A1
(43) Pub. Date: Oct. 1, 2026

(54) Detachable illumination module

(71) Applicant: Festool GmbH, Wendlingen am Neckar (DE)

(72) Inventors: Andreas Randecker, Dettingen (DE); Wolfgang Spengler, Neidlingen (DE); Johannes Rau, Plochingen (DE); Boris Seyfried, Reutlingen (DE)

(21) Appl. No.: 18/998,152

(22) PCT Filed: Jul. 27, 2023
(86) PCT No.: PCT/EP2023/070851

§ 371 Date: Jan. 24, 2025

(30) Foreign Application Priority Data
Jul. 29, 2022 (EP) 22187853.1

(51) Int. Cl. B23D 59/00; B27B 9/02; B27G 19/04; F21V 23/00; F21V 33/00

(52) U.S. Cl. CPC B23D 59/003; B27B 9/02; B27G 19/04; F21V 23/009; F21V 33/0084; B23D 59/0064

(57) ABSTRACT

The invention relates to an illumination module (70) for a hand-held circular saw (10) having a lamp housing (75), inside which a power supply is accommodated, to which a illumination element (71) is electrically connected, wherein the illumination element (71) is disposed to emit light in a light emission area of an end of the lamp housing (75), towards a working area of the hand-held circular saw (10), and wherein the lamp housing (75) has a fastening section (76) forming a mounting end having a contact surface (72) disposed and oriented to be detachably to be detachably mounted to a mounting surface of the hand-held circular saw (10). Such an arrangement provides the user with the option of illuminating the work area next to the hand-held circular saw depending on the user's individual requirements.

The invention relates to an illumination module for a hand-held circular saw.

JP2022-46093 discloses a hand-held circular saw having a protective cover encompassing a chip-guiding space. A saw blade is held in the chip-guiding space. An illumination arrangement is disposed behind the saw blade in the feed direction in the chip removal area. The illumination arrangement emits its light transverse to the axis of rotation of the saw blade on both sides of the saw blade. In that way, the saw blade, which is in the light path of the illumination arrangement, casts a shadow on the workpiece to be processed. Such an arrangement does not suffice to sufficiently illuminate the working area laterally of the hand-held circular saw.

The invention addresses the problem of providing an illumination module for a hand-held circular saw, which illumination module a user can use to suitably illuminate the working area next to the hand-held circular saw as required.

This problem is solved by an illumination module in accordance with claim 1. Accordingly, proposition is made for an illumination module having a lamp housing, inside which a power supply is accommodated to which an illumination element is electrically connected, wherein the illumination element is disposed to emit light into a light emission area of an end of the lamp housing, towards a working area of the hand-held circular saw and wherein the lamp housing has a fastening section forming a mounting end having a contact surface disposed and oriented to be detachably mounted to a mounting surface of the hand-held circular saw.

The user is therefore provided with an illumination module, which the user can attach to the outside of the hand-held circular saw as required to illuminate the work area appropriately. The illumination module forms a stand-alone unit having a power supply such that it is independent of the power supply of the hand-held circular saw. In certain work situations, for instance when sawing close to a wall or when sawing with a large miter angle, the illumination module may collide with the workpiece, for instance. The user can then simply remove the illumination module from the circular saw and perform the sawing task. Afterwards, the mounting end of the illumination module can simply be reattached to the hand-held circular saw. In this way, the user can use the illumination module as required and optimally illuminate the work area. Preferably, the hand-held circular saw has a mechanical interface to which the mounting end of the illumination module can be attached. Preferably, this predetermined interface is provided on the outside of a protective cover of the hand-held circular saw that covers the saw blade.

Preferably, the illumination module is rod-shaped to be easy to handle and compact when attached to the hand-held circular saw.

Preferably, provision may be made for the contact surface of the lamp housing to be preferably designed to be plane to come into contact with a plane mounting surface of the hand-held circular saw.

According to a preferred variant of the invention, provision may be made for the mounting end to extend between a housing top face of the lamp housing and a housing underside of the lamp housing, and for the light emission area of the illumination element to be disposed in the area of the housing underside of the lamp housing, preferably in an area which is disposed at a distance of less than 30 mm from the housing underside in the direction of the housing top face of the lamp housing. In such an arrangement, the illumination module can be attached to the outside of the hand-held circular saw in such a way that the housing underside of the lamp housing is just above to the workpiece to be machined. This means that the light emission area is also positioned just above the top face of the workpiece. The light emission area is therefore disposed such that the light emitted by the illumination element can be directed across the surface of the workpiece to achieve optimum illumination. Ideally, the illumination element emits its light in the feed direction of the hand-held circular saw so as not to dazzle the user.

The lamp housing may have a switch for activating and deactivating the illumination element. Preferably, the switch is disposed at least 30 mm away from the underside of the lamp housing and/or the switch is disposed in the area of the housing top face of the lamp housing. The user can therefore switch the illumination module disposed on the hand-held circular saw on and off away from the cutting area of the hand-held circular saw, which eliminates or at least significantly reduces the risk of injury.

If provision is made for a cone axis of the light cone generated by the illumination module to extend in the direction parallel to the mounting end, then the light emitted by the illumination element can be guided close to the mounting end, which results in an improved illumination of the cutting area when the illumination module is disposed on the hand-held circular saw.

According to a preferred variant of the invention, provision may be made for the cone axis of the light cone generated by the illumination module to be swiveling about a longitudinal axis of the lamp housing extending in parallel to the mounting end and/or between the housing underside and the housing top face of the lamp housing.

The illumination module can then be handled easily if provision is made for the illumination module to have a design whose maximum outer dimension is <90 mm, wherein preferably provision is made for the maximum width and depth to each be less than 40 mm and for the maximum length to be less than 90 mm. Preferably, the depth of the illumination module is the dimension that extends perpendicular to the mounting end and/or the length of the illumination module is the dimension that extends in parallel to the mounting end. The illumination module then protrudes only slightly beyond the outside of the hand-held circular saw and restricts the working area only slightly.

The width of the illumination module preferably extends in the feed direction when mounted. For instance, the height of the illumination module can be perpendicular or transverse to the workpiece surface of the workpiece to be processed.

A possible variant of the invention can be such that the mounting end, the light exiting direction, in particular the cone axis of the light cone generated by the illumination module, and the longest dimension of the lamp housing are perpendicular to one another. Such an illumination module can be attached to the outside of a protective cover that covers the saw blade of the hand-held circular saw to save space.

If provision is made for the lamp housing to have a form-fitting element in the area of the mounting end, which form-fitting element is designed and disposed to interact with a mating form-fitting element of the hand-held circular saw or similar machine tool to form a form-fitting connection in the direction of the plane of the mounting end, then a secure assignment of the illumination module to the machine tool is provided. In particular, low fastening forces perpendicular to the mounting end can guarantee the reliable assignment of the illumination module to the machine tool, even in harsh conditions.

To this end, for instance, provision may also be made for the form-fitting element to be designed as a mount recessed into the mounting end of the lamp housing. A mating form-fitting element of the hand-held circular saw can engage with this mount to establish the form-fitting connection. The mating form-fitting element may, for instance, be formed by a component that protrudes from the hand-held circular saw. In particular, the mating form-fitting element may be a separate component that is attached or can be attached to the protective cover that covers the saw blade. In this way, the mating form-fitting element can be easily retrofitted to an existing hand-held circular saw to be able to arrange the illumination module according to the invention on the hand-held circular saw. However, it is also conceivable that the mating form-fitting element is integrally molded onto the protective cover of the hand-held circular saw.

According to the invention, the illumination module has a mechanical interface, which can be used to detachably connect the illumination module to the hand-held circular saw. In particular, the lamp housing can therefore bear a connection arrangement that is designed to form a detachable connection with the hand-held circular saw or similar machine tool.

Preferably provision may be made for the connection arrangement to be a magnet or a ferromagnetic component, which is preferably held in the lamp housing or is embedded at least sectionally in a casing element of the lamp housing. Such a magnetic connection is easy for the user to handle and can also be used reliably in harsh construction site conditions.

However, it is also conceivable that the connection arrangement is part of a hook-and-loop connection or that the connection arrangement is part of an adhesive connection, or that the connection arrangement is part of a snap-in connection, in particular a snap-in element.

If the light cone emitted by the illumination element is designed to emit at least 50% of the light quantity at an angle <10°, this results in a focused light cone that results in a particularly good illumination of the workpiece surface.

As described above, the illumination module has its own power supply, which can be provided by a rechargeable battery, for instance. To prevent the illumination module from switching off abruptly when the battery charge level is too low and thus startling the user, one variant of the invention can be such that a control device is provided, which dims the illumination element gradually or continuously when the charge capacity of the power supply falls below a predetermined level. This improves occupational safety.

A possible variant of the invention can be such that a setting mechanism is provided between the mounting end and the illumination element, which setting mechanism can be used to alter the position of the illumination element relative to the mounting end and/or the cone axis of the light cone and/or the lamp housing, wherein preferably provision is made for the setting mechanism to have a swivel bearing and/or a sliding bearing. In this way, the user has the option of influencing the light path of the illumination element and adapting it to the user's needs.

The problem of the invention is also solved by a hand-held circular saw having an illumination module according to any of claims 1 to 13.

Particularly preferably, the hand-held circular saw has a saw-blade holder for mounting a saw blade, which saw-blade holder can be rotated about a drive axis by means of a drive assembly, wherein a protective cover is provided, which encompasses a chip-guiding space, inside which a saw-blade mounting area is formed, which is disposed and designed to hold the saw blade in a working position, wherein the protective cover has a lateral casing, which delimits the chip-guiding space at the end facing away from the drive assembly, wherein the illumination module is mounted on the outer face of the lateral casing facing away from the saw-blade mounting area by means of its fastening section, wherein the illumination module illuminates the cutting area of the hand-held circular saw at least sectionally, and wherein the illumination element is preferably disposed behind the saw-blade mounting area in the feed direction of the hand-held circular saw.

If, according to a variant of the invention, additionally provision is made for the illumination module to be disposed and oriented in such a way that the light emitted by the illumination element is predominantly emitted in the feed direction of the hand-held circular saw, and for the light emitted by the illumination element to extend at least sectionally, preferably completely, in a light-guiding area, which is separated from the dust-conveying area of the chip-guiding space, then not only a simple design is achieved, but also the reliable and glare-free illumination of the cutting area.

The invention is explained in greater detail below based on an exemplary embodiment shown in the drawings. In the Figures:

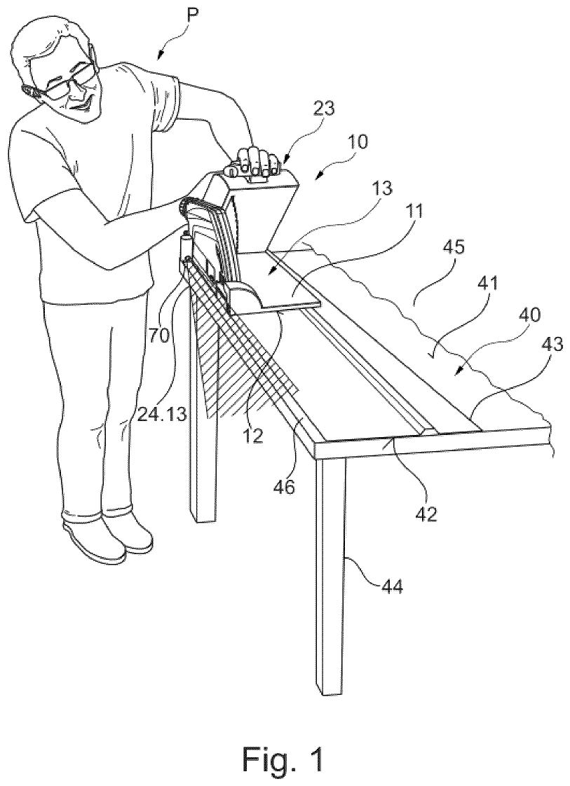

FIG. 1 shows a typical work situation, in which a user guides a hand-held circular saw along a guide rail to cut a workpiece,

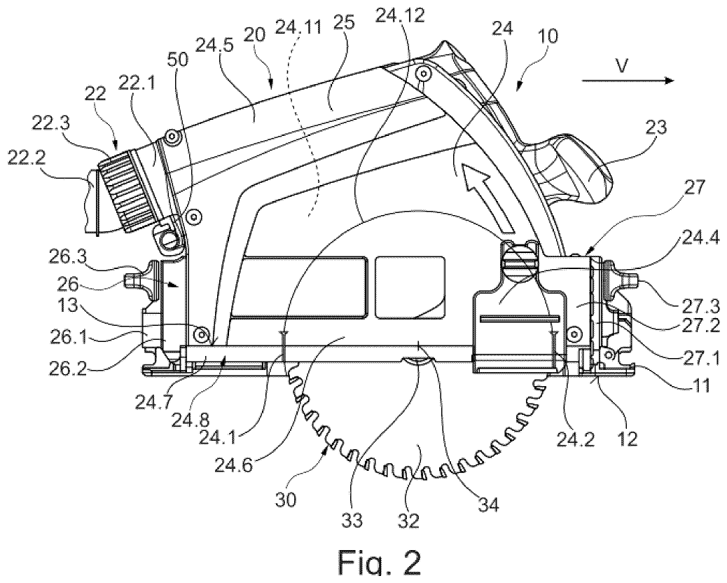

FIG. 2 shows a side view of a hand-held circular saw,

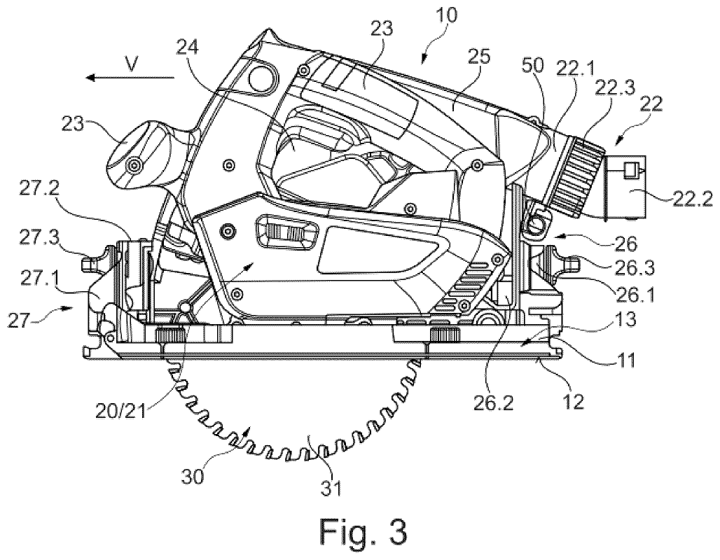

FIG. 3 shows the hand-held circular saw of FIG. 2, viewed from the opposite end of FIG. 2,

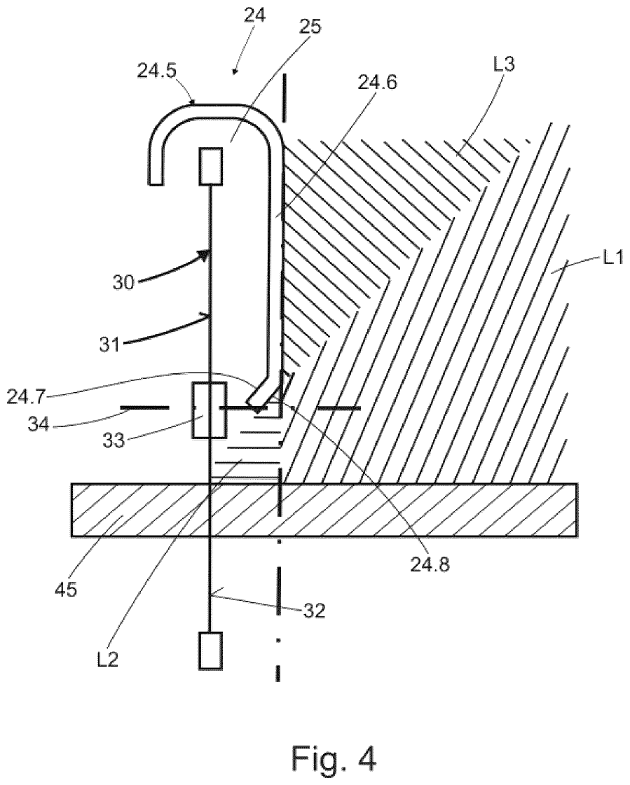

FIG. 4 shows a symbolic view of various illumination areas assigned to a protective cover of the hand-held circular saw,

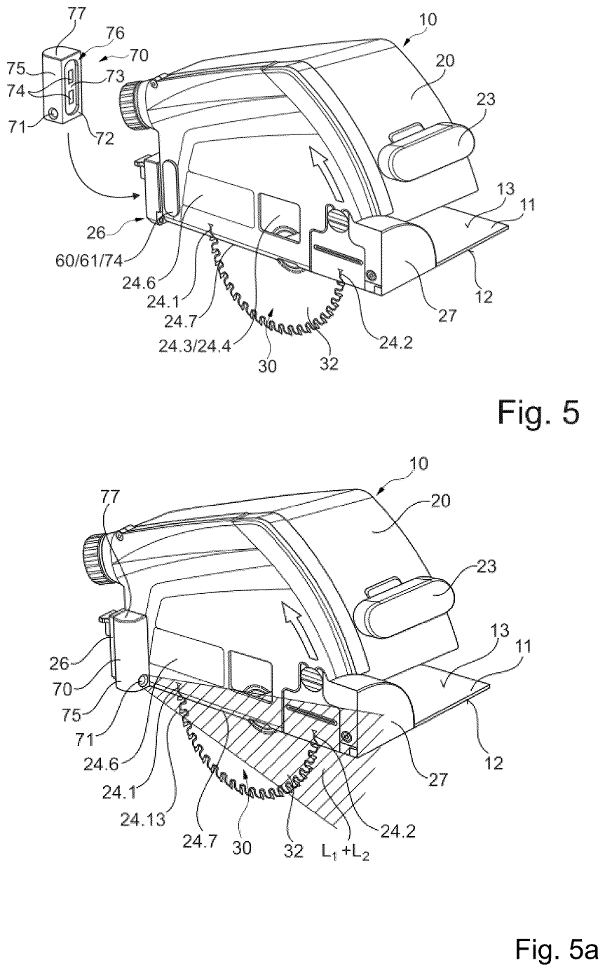

FIG. 5 shows a simplified representation of the hand-held circular saw of FIGS. 2 and 3 with a perspective side view and an exploded view of an illumination module, and

FIG. 5a shows the representation of FIG. 5 in the assembled state.

FIG. 1 shows a typical work situation in which an operator P processes a workpiece 45 lying on a work table 44 using a hand-held circular saw 10. The hand-held circular saw 10 is used to cut off a section 46 of the workpiece 45. For this operation, the rail underside 42 of a guide rail 40 is placed on the top face of the workpiece 45. The hand-held circular saw 10 is placed on the top face 41 of the guide rail 40. The hand-held circular saw 10 can be guided in the longitudinal direction of the rail on a guide element 43 of the guide rail 40 in the known manner.

In accordance with the invention, an illumination module 70 is mounted on the hand-held circular saw 10, which illumination module can be used to direct light onto the top face of the workpiece via a light-guiding area 24.13.

FIGS. 2 and 3 show the technical design of the hand-held circular saw 10. As these representations show, the hand-held circular saw 10 has a guide plate 11, which can be used to place the former on the guide rail 40. On its downward-facing support end 12, the hand-held circular saw 10 has a guide mount that interacts with the guide element 43 of the guide rail 40 for longitudinal guidance. In the area of its top face 13, the guide plate 11 has a retaining structure, which can be used to connect a drive assembly 20 to the guide plate 11.

The drive assembly 20 has a drive motor 21, which can be used to rotate a saw blade holder 33. A saw blade 30 can be interchangeably attached to the saw blade holder 33. FIG. 2 illustrates the position of the drive axis 34 about which the saw blade 30 can be rotated. On its side facing the drive motor 21, the saw blade 30 has an inner saw blade face 31 and an outer saw blade face 32 on the opposite side, which can be seen in FIG. 2. The inner saw blade face 31 is illustrated in FIG. 3.

When mounted, the saw blade 30 is accommodated in a saw-blade-mounting area 24.12 of a protective cover 24. This hand-held circular saw 10 is a plunge-cut saw, in which the drive assembly 20 and the saw blade 30 can be swiveled about a swivel axis extending perpendicular to the image plane as shown in FIGS. 2 and 3 to swivel the saw blade 30 at least partially out of the protective cover 24 into a plunge-cut position. Such a plunge-cut position with the saw blade 30 swiveled to the maximum is shown in FIGS. 2 and 3.

The protective cover 24 may have a connection fitting 22.1, which is preferably integrally connected to the protective cover 24. The connection fitting 22.1 serves as suction connection 22. A coupling piece 22.2 can be detachably attached to the suction connection 22 by means of a locking element 22.3. The coupling piece 22.2 can be part of a suction hose of a chip-extraction system or be a connection piece for such a suction hose. During machining, the chip-extraction system is used to extract chips from a chip-guiding duct 25 encompassed by the protective cover 24, which chip-guiding duct is spatially connected to the chip-guiding space 24.11.

As FIG. 2 illustrates, the protective cover 24 can form a lateral casing 24.6, which delimits the chip-guiding space 24.11 on the end facing away from the drive assembly 20. In other words, the lateral casing 24.6 delimits the chip-guiding space 24.11 in the area of the outer saw blade face 32.

The lateral casing 24.6 extends essentially perpendicular to the drive axis 34.

At its lower end, the lateral casing 24.6 can have a strip-shaped limiting element 24.7. The limiting element 24.7 forms an outer limiting surface 24.8, which is angled inwards towards the saw blade 30.

FIG. 2 further shows that the lateral casing 24.6 bears two markings, namely a rear area marking 24.1 and a front area marking 24.2. The cutting area of the saw blade 30 is marked between the two area markings 24.1 and 24.2 for the user P to be able to recognize it. The two range markings 24.1 and 24.2 thus illustrate the rear and front saw blade limits in the maximum plunge-cut position of the saw blade 30.

As FIG. 4 illustrates, there may be a recess 24.3 in the front cutting area of the saw blade 30 in the lateral casing 24.6, through which it is possible to view the front cutting area of the saw blade 30. The recess 24.3 can be covered with a detachable and transparent window 24.4. This window 24.4 may bear the front area marking 24.2.

FIG. 4 further illustrates that the protective cover 24 may have an upper cover area 24.5, which forms the above-mentioned chip-guiding duct 25.

FIGS. 2 and 3 further illustrate that the drive assembly 20 can be swivel connected to the guide plate 11 to permit miter cuts. For this purpose, the drive assembly 20 is connected to the guide plate 11 by means of a rear miter bearing 26 and a front miter bearing 27.

The rear miter bearing 26 has a fixed bearing piece 26.1, which is connected to the guide plate 11. A movable bearing piece 26.2 is connected to the fixed bearing piece 26.1 by means of a swivel bearing, wherein the movable bearing piece 26.2 is coupled to the drive assembly 20.

The front miter bearing 27 is designed in the same way and has a fixed bearing piece 27.1 and a movable bearing piece 27.2. To lock the set swivel position, the two miter bearings 26 and 27 each have a locking device 26.3, 27.3.

The setting and guidance of the hand-held circular saw 10 is facilitated by means of a handle 23 of the drive assembly 20, wherein the handle 23 can also have the trigger for activating the drive motor 21 in the usual manner.

FIGS. 5 and 5a illustrate that an illumination module 70 can be interchangeably connected to the hand-held circular saw 10.

The illumination module 70 has an illumination element 71, which is accommodated in a lamp housing 75.

The illumination module 70 can be interchangeably connected to the hand-held circular saw 10. A connection arrangement can be used to attach the illumination module 70.

As the representations show, the illumination module 70 is disposed behind the saw blade 30 in the feed direction of the hand-held circular saw 10. The light emitted by the illumination module 70 is essentially directed in the feed direction V, such that it at least partially illuminates the sawing area between the two area markings 24.1 and 24.2. In particular, the illumination module 70 sufficiently illuminates the area around the front area marking 24.2.

FIG. 4 illustrates a section through the protective cover 24 perpendicular to the support end 12 of the guide plate 11 and through the drive axis 34.

As this representation illustrates, different illumination areas L1, L2, L3 can be formed depending on the arrangement of the illumination module 70 in relation to the lateral casing 24.6. The illumination areas L1 and L2 are particularly suitable illumination areas. The illumination area L1 is limited by the lateral casing 24.6 and the surface of the workpiece 45 to be processed. The illumination area L2 is limited by the workpiece surface and the limiting surface 24.8 of the limiting element 24.7 and extends up to or almost up to the end of the saw-blade-mounting area 24.12 facing the lateral casing 24.6 or up to the outer saw blade face 32.

The illumination area L3 is less suitable as it does not illuminate the workpiece surface.

The exemplary embodiment of FIGS. 5 and 5a can preferably be used to at least partially illuminate the illumination areas L1 and L2.

As the drawings illustrate, an illumination module 70 can be interchangeably connected to the protective cover 24, preferably to the lateral casing 24.6 of the protective cover 24. For this purpose, the illumination module 70 has a fastening section 76, which can be interchangeably connected to the protective cover 24.

The illumination module 70 has a lamp housing 75, in which an illumination element 71 is accommodated. Furthermore, a power supply, in particular a rechargeable battery, may be disposed in the lamp housing 75 to supply the illumination element 71 with power.

The lamp housing 75 has a contact surface 72 in the area of a mounting end, which is disposed and designed to be placed against the outer face of the lateral casing 24.6. A form-fitting element 73 may be present in the area of the contact surface 72, which form-fitting element comes into contact with a mating form-fitting element of the protective cover 24 to block a displacement of the lamp housing 75 in the plane parallel to the contact surface 72 and thus in the direction of the outer face of the lateral casing 24.6. The form-fitting element 73 may be designed as a recess that is recessed into the contact surface 72. The mating form-fitting element can be formed by an elevation that protrudes beyond the outer face of the lateral casing 24.6.

A magnetic connection can be used to connect the illumination module 70 to the protective cover 24. For instance, the lamp housing 75 may include a magnet 74 (or ferromagnetic part), which interacts with a ferromagnetic part (or a magnet) of the protective cover 24 to form the magnetic connection.

In this exemplary embodiment, the ferrous part (or the magnet 74) is applied to the outer face of the lateral casing 24.6 and preferably also forms the mating form-fitting element at the same time. However, it is also conceivable that the ferrous part (or the magnet 74) is at least partially integrated into the material of the lateral casing 24.6 or is disposed on the inner face of the lateral casing 24.6 facing away from the outer face of the lateral casing 24.6.

The lamp housing 75 forms a cover section on its top face, which cover section is used with a switch 77 to switch the illumination element 71 on or off.

Preferably, when the illumination module 70 is mounted, the lamp housing 75 bears the illumination element 71 at its end facing the guide plate 11. Particularly preferably, the lamp housing 75 holds the illumination element 71 in the area of the limiting surface 24.8 such that the illumination area L2 can also be at least partially illuminated, as illustrated in FIG. 7a, where the light-guiding area 24.13 is shown symbolically.

This drawing also shows that the arrangement of the switch 77 on the lamp housing 75 on the top end facing away from the guide plate 11 is advantageous, as the user P can activate the illumination element 71 away from the cutting area.

FIG. 5A illustrates that the mounting end of the fastening section 76 of the lamp housing 75 extends between a housing top face and a housing underside. The light emission area of the illumination element 71 is disposed in the area of the housing underside and preferably in an area that is spaced less than 30 mm apart from the underside in the direction of the top face of the lamp housing 75, such that an illumination close to the workpiece is possible.

The illumination module 70 generates the light cone shown schematically in FIG. 5a. The cone axis of this light cone forms the main light axis 78, which extends in the direction of the mounting end, preferably in the direction in parallel to the mounting end. Particularly preferably, this main light axis 78 extends in the feed direction V or essentially in the feed direction V.

As the drawings illustrate, it is advantageous if the illumination module 70 protrudes as little as possible beyond the lateral casing 24.6, such that it has a design depth of preferably <40 mm in the direction perpendicular to the contact surface 72. The longest extent of the illumination module 70 extends perpendicular to the workpiece surface, such that the switch 77 is positioned as far away as possible from the cutting area of the saw blade 30.

The representations further illustrate that the illumination module 70 is designed such that the mounting end (in particular the contact surface 72), the light exiting direction, in particular the cone axis of the light cone generated by the illumination module 70, and the longest dimension of the lamp housing 75 are perpendicular to one another. In the variant of the invention described above, the illumination module 70 is disposed and oriented in such a way that the light emitted by the illumination element 71 is predominantly emitted in the feed direction V of the hand-held circular saw 10. The light emitted by the illumination element 71 extends at least sectionally, preferably completely, in a light-guiding area 24.13, which is separated from the dust-conveying area of the chip-guiding space 24.11. The illumination module 70 holds the illumination element 71 behind the saw-blade-mounting area 24.12 in the feed direction.

1-18. (canceled)

19. An illumination module for a hand-held circular saw, the illumination module comprising:
a lamp housing;
a power supply accommodated inside of the lamp housing; and
an illumination element electrically connected to the power supply and disposed to emit light in a light emission area of an end portion of the lamp housing towards a working area of the hand-held circular saw;
wherein the lamp housing includes a fastening section forming a mounting end including a contact surface configured to be detachable mounted to a mounting surface of the hand-held circular saw.

20. The illumination module of claim 19, wherein:
the lamp housing includes a housing top face and a housing underside;
the mounting end of the lamp housing extends between the housing top face and the housing underside; and
the light emission area of the illumination element is disposed at a distance of less than 30 mm from the housing underside.

21. The illumination module of claim 20, further comprising:
a switch connected to the lamp housing for activating and deactivating the illumination element, the switch being disposed at a distance of at least 30mm from the housing underside and/or the switch being disposed on the housing top face.

22. The illumination module of claim 20, wherein:
an extent of the mounting end from the housing top face to the housing underside is greater than an extent of the housing top face or the housing underside perpendicular to the mounting end of the lamp housing.

23. The illumination module of claim 20, wherein:
a maximum outer dimension of the lamp housing is less than 90mm.

24. The illumination module of claim 20, wherein:
a maximum length of the lamp housing between the housing top face and the housing underside is less than 90mm and a maximum width and depth of the lamp housing are each less than 40mm.

25. The illumination module of claim 19, wherein:
a cone axis of a light cone generated by the illumination module extends in a direction parallel to the mounting end of the lamp housing.

26. The illumination module of claim 19, wherein:
a light exiting direction of a light cone generated by the illumination module is perpendicular to a longest dimension of the lamp housing.

27. The illumination module of claim 19, wherein:
the mounting end of the lamp housing includes a form-fitting element configured to interact with a mating form-fitting element of the hand-held circular saw to form a form-fitting connection in a direction of the mounting end.

28. The illumination module of claim 27, wherein:
the form-fitting element of the mounting end is configured as a mount recessed into the mounting end of the lamp housing.

29. The illumination module of claim 19, wherein:
the lamp housing includes a connection arrangement configured to form a detachable connection with the hand-held circular saw.

30. The illumination module of claim 29, wherein:
the connection arrangement is selected from the group consisting of a magnet, a ferromagnetic component, a hook-and-loop connection, an adhesive connection and a snap-in connection.

31. The illumination module of claim 19, wherein:
a light cone emitted by the illumination element is configured such that at least 50% of a total amount of light emitted is within an angle of less than 10 degrees.

32. The illumination module of claim 19, wherein:
the power supply includes a rechargeable battery; and
the illumination module further includes a control device configured to dim the illumination element gradually or continuously when a charge capacity of the rechargeable battery falls below a predetermined level.

33. The illumination module of claim 19, further comprising:
a setting mechanism between the mounting end and the illumination element, the setting mechanism being configured to alter a position of the illumination element relative to the mounting end.

34. The illumination module of claim 33, wherein:
the setting mechanism includes a swivel bearing and/or a sliding bearing.

35. The illumination module of claim 19, wherein:
the illumination module is rod-shaped.

36. A hand-held circular saw including the illumination module of claim 19.

37. A hand-held circular saw, comprising:
a saw-blade holder configured to mount a saw blade;
a drive assembly configured to rotate the saw blade about a drive axis;
a protective cover encompassing a chip-guiding space and forming a saw-blade-mounting area inside the protective cover, the protective cover being configured to hold the saw blade in a working position, the protective cover including a lateral casing delimiting the chip-guiding space at an end facing away from the drive assembly; and
an illumination module mounted on an outer face of the lateral casing facing away from the saw-blade-mounting area, the illumination module including:
a lamp housing;
a power supply accommodated inside of the lamp housing; and
an illumination element electrically connected to the power supply and disposed to emit light towards a working area of the hand-held circular saw;
wherein the lamp housing includes a fastening section forming a mounting end including a contact surface configured to be detachably mounted to the outer face of the lateral casing.

38. The hand-held circular saw of claim 37, wherein:
the illumination module is disposed and oriented such that the light emitted by the illumination element is predominantly emitted in a feed direction of the hand-held circular saw, and such that the light emitted by the illumination element extends at least partially in a light-guiding area separate from a dust-guiding area of the chip-guiding space.
